(19) United States
(12) Patent Application Publication
(10) Pub. No.: US 2011/0272920 A1
(43) Pub. Date: Nov. 10, 2011

(54) GLIDING BOARD

(75) Inventor: David ADAMCZEWSKI, Annecy (FR)

(73) Assignee: SALOMON S.A.S., Metz-Tessy (FR)

(21) Appl. No.: 13/102,442

(22) Filed: May 6, 2011

(30) Foreign Application Priority Data
May 7, 2010 (FR) 10/01962

(51) Int. Cl. B32B 3/00

(52) U.S. Cl. 280/601

(57) ABSTRACT

A gliding board having a length measured along a longitudinal direction, between a first end and a second end, a width measured along a transverse direction, between a first edge and a second edge, and a height measured between a bottom surface and a top surface, the gliding board including a lower reinforcement and an upper reinforcement. The board includes a median longitudinal spacer, the spacer being arranged between the lower reinforcement and the upper reinforcement.

### CROSS-REFERENCE TO RELATED APPLICATION

This application is based upon the French priority Patent Application No. 10.01962, filed May 7, 2010, the disclosure of which is hereby incorporated by reference thereto, and the priority of which is hereby claimed under 35 U.S.C. §119.

### BACKGROUND

1. Field of the Invention

The invention relates to the field of gliding boards intended for the practice of a sport such as surfing on snow or water, skiing on snow or water, and other sports that utilize gliding boards. A particular field to which the invention relates to that of snowboards, including variations of snowboards and boards of derivative sports.

2. Background Information

A board conventionally has a length measured along a longitudinal direction, between a first end and a second end, a width measured along a transverse direction, between a first edge and a second edge, and a height measured between a bottom surface and a top surface.

Heightwise, the board conventionally includes a lower reinforcement, a core, and an upper reinforcement. The term “lower” refers to the reinforcement, or load-carrying layer, that is the closest to the ground when the board glides or rolls under normal conditions of use. By analogy, the term “upper” refers to the reinforcement, or load-carrying layer, that is the farthest from the ground. The core serves to keep the reinforcements apart. Thus, the board has a sandwich structure, which is both lightweight and mechanically strong. This is particularly the case in snowboarding.

In this discipline, the user has both feet retained on the board, in a first receiving zone and, a second receiving zone, respectively. The feet are each oriented in a substantially transverse direction relative to the board. This makes it easier to receive lateral supporting forces, either with the heels or with the toes, and to apply such forces when controlling the board.

The board is steered while travelling downhill, along more or less steep slopes, even though the ground may temporarily be horizontal or even rise. In these cases, the initial momentum created in the downhill phase is sufficient to maintain the speed of the board. It is understood that the user, once at the bottom of the hill, will seek to ascend the slope again to start over. To this end, a mechanical lift, such as a chair lift, a ropeway, or the like, is typically used.

A user sometimes may decide to climb a slope on his or her own, such as in the case of those who might be referred to as backcountry snowboarders. To this end, it is known to use two narrower boards, which can be selectively either fixed to one another or separated. In this discipline, sometimes referred to as splitboarding, the boards are separated and used as touring skis for the ascent. In this case, each board receives one foot of the user. Conversely, during the descent, the two narrow boards are assembled side by side to form a wider gliding apparatus. This apparatus is similar to a wide board, and therefore receives both feet of the user. A gliding apparatus comprising two narrow boards allows the user to maintain autonomy. This apparatus has the advantage of being operated in the same manner as a conventional wide board. The user can therefore take advantage of his/her experience, with no particular training.

However, an apparatus comprising two narrow boards has at least one drawback, namely, its manufacturing cost and, consequently, its selling price. Indeed, it is necessary to make two complete boards for this apparatus, instead of one for an apparatus comprised of a single wide board.

To circumvent the problem of price, certain users cut a wide board in half, along a median longitudinal direction. Two narrow boards are obtained, which can be fixed to one another or remain separate. In other words, it is possible to make a wide gliding apparatus, as described above, from a conventional wide board. However this apparatus, which can be considered as a derivative, has several drawbacks.

Indeed, as a general observation, a narrow board, obtained by cutting a wide board, deteriorates faster than a narrow board that was originally manufactured as such.

The deterioration is primarily mechanical, in the sense that the lower and/or upper reinforcements deform excessively, show incipient cracks or ruptures, or split open or even break, especially in the area of the cut on the original wide board. One can say that the cut, as a consequence, weakens each narrow board obtained, from the mechanical standpoint.

The deterioration is also physical, in a broader sense. Indeed, the cut renders each narrow board obtained more or less vulnerable to penetration, or simply to the action, of foreign bodies, material, or debris. For example, friction between the out surface and the snow or between the cut surface and various objects, such as rocks, sand, and pebbles in the snow, deteriorates the reinforcements or a core arranged between the reinforcements. Also, water can occasionally penetrate into the structure of the narrow board, in the area of the cut. This intrusion may damage the connections between the various components of the board, or the components themselves. In other words, water promotes a dismantling of the board structure.

### SUMMARY

In view of the foregoing, the invention generally provides an improved so-called narrow board, obtained by splitting a wide board. It is to be understood that the concepts of narrowness and wideness are relative. The invention slows or prevents the deterioration of a board obtained by cutting. More specifically, the invention reduces or prevents mechanical deterioration, particularly in the area of the cut. In addition, the invention limits or avoids physical deteriorations related to the penetration or action of foreign bodies, material, and debris. For example, the invention provides for the resistance to the penetration of water into the structure of the board.

Generally speaking, the invention prolongs the life of a final board obtained by modifying an original board.

To this end, the invention is directed to a gliding board that has a length measured along a longitudinal direction, between a first end and a second end, a width measured along a transverse direction, such as perpendicular to the longitudinal direction, between a first edge and a second edge, and a height measured between a bottom surface and a top surface, the gliding board having a lower reinforcement and an upper reinforcement, such as a lower reinforcement layer and an upper reinforcement layer.

A gliding board according to the invention includes a median longitudinal spacer, the spacer being arranged between the lower reinforcement and the upper reinforcement.

Due to its location, the spacer is an element that is cut through when the board is divided into two half-boards which, comparatively, become narrow boards. This means that a narrow board includes a portion of the spacer in the area of the cut. The spacer portion is in the area of an edge or edge region of the board thus obtained. The spacer portion in the area of an edge constitutes a beam which maintains, or supports, the upper and lower reinforcements with respect to one another, along the totality or a section of the cut. Therefore, the various stresses and forces exerted on the narrow board are more evenly distributed between the upper and lower reinforcements. In other words, the beam limits the magnitude of the forces that are exerted on a reinforcement. A resulting advantage is a greater mechanical strength of the so-called narrow board, particularly in the area of the cut on the original wide board.

The beam of a narrow board also behaves as a barrier to the penetration of foreign bodies. The beam can block, completely or only partially, the area demarcated between the upper and lower reinforcements. This arrangement renders the board structure impervious, or at least resistant, to water penetration. This keeps the inside of the board structure dry, either permanently or for a significant period of time. In other words, the components of the board and/or the connections or adhesion between the components, are protected from water or moisture; A resulting advantage is a better physical strength of the board. Ultimately, the life of a board obtained by cutting, according to the invention, is increased.

### BRIEF DESCRIPTION OF DRAWING

Other characteristics and advantages of the invention will better understood from the description that follows, with reference to the annexed drawings illustrating, by way of non-limiting embodiments, how the invention can be embodied, and in which:

FIG. 1 is a perspective view of a board according to all of the embodiments of the invention;

FIG. 2 is a cross section along the line II-II of FIG. 1, of a first embodiment of the invention;

FIG. 3 is a cross section, similar to FIG. 2, of a second embodiment of the invention;

FIG. 4 is a cross section along the line IV-IV of FIG. 2;

FIG. 5 is a cross section, similar to FIG. 4, of an alternative construction that is part of the first embodiment of the invention;

FIG. 6 is a cross section along the line VI-VI of FIG. 2;

FIG. 7 is a cross section along the line VII-VII of FIG. 6;

FIG. 8 is a cross section along the line VIII-VIII of FIG. 3;

FIG. 9 is a cross section along the line IX-IX of FIG. 8;

FIG. 10 is a top view of the board of FIG. 1, the board being cut along a median longitudinal line to obtain two half-boards; and

FIG. 11 is similar to FIG. 10, showing changes made to the half-boards.

### DETAILED DESCRIPTION

Although the embodiments described hereinafter relate to a snowboard, it is to be understood that the invention also relates to other boards, such as those intended for mono-skiing. In this case, the user still has both feet on his apparatus, but oriented along a longitudinal direction thereof rather than intersecting therewith.

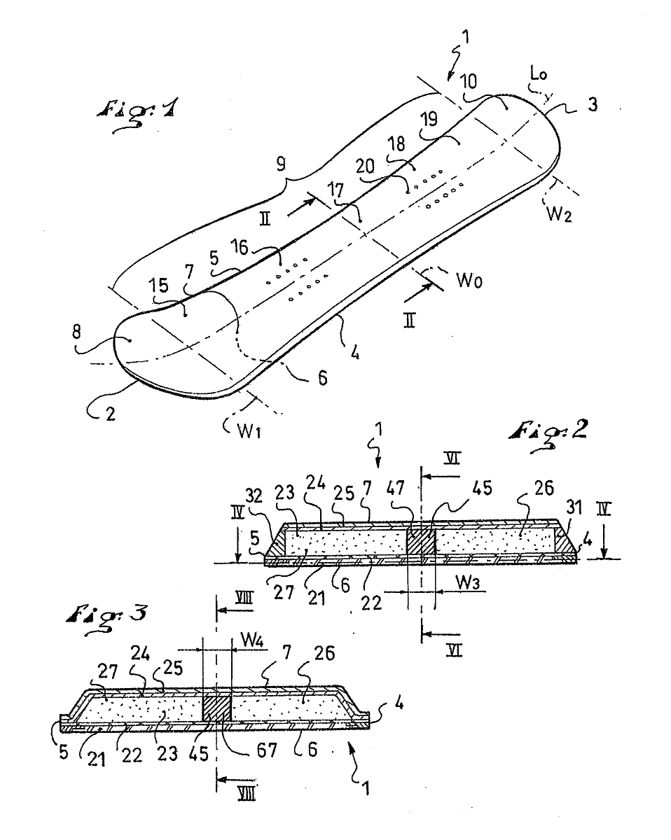

The first embodiment is illustrated in FIGS. 1, 2, 4 to 7, 10, and 11.

In a known fashion, as shown particularly in FIG. 1, a snowboard 1 has a length measured along a longitudinal direction, between a first end 2 and a second end 3. The longitudinal direction is referenced by means of the central longitudinal axis Lo, which lies within a vertical longitudinal median plane. Each of the first and second ends 2, 3 is rounded, but could alternatively have a different shape, such as that of a relatively pointed tip or a fin. The board 1 also has a width measured along a transverse direction, between a first lateral edge 4 and a second lateral edge 5, as well as a height measured between a bottom or gliding surface 6 and a top or receiving surface 7. The transverse direction is referenced by means of the median transverse axis Wo. The circumference of the board includes the ends and the edges. For each edge, the sidecut according to the first embodiment is concave with respect to the longitudinal direction Lo.

The transverse direction along axis Wo is perpendicular to the longitudinal direction along axis Lo and parallel to the gliding surface 6.

The board 1 also has, from the first end 2 to the second end 3, a first end zone 8, a first contact line W1, a central zone 9, a second contact line W2, and a second end zone 10. The central zone 9 itself successively includes, between the contact lines W1 and W2, a first intermediate zone 15, a first retention zone 16, a second intermediate zone 17 arranged in the area of the median axis Wo, a second retention zone 18, and a third intermediate zone 19. The end zone 8, intermediate zone 15, retention zone 16, intermediate zone 17, retention zone 18, intermediate zone 19, and end zone 10 succeed one another longitudinally. As can be seen in FIG. 6, for example, the end zones 8, 10 extend upwardly from the contact lines W1, W2, toward the ends 2 and 3, respectively, in the form of upturned tips or shovels.

Each retention zone 16, 18 is structured and arranged to receive a device for retaining the foot or boot of a user, such as a binding. The devices, not shown, can be affixed to the board 1 with a plurality of screws, for example. For such purpose, each retention zone 16, 18 is provided with threaded holes 20.

Each of the contact lines W1, W2 is a transverse line, or a substantially transverse line, of the board 1, in the area of which the gliding surface 6 contacts a flat surface when the board 1 rests on the surface without any external influence.

The general appearance of the board 1 is that of an elongated plate. According to the first embodiment, the bottom surface 6 is slightly concave between the contact lines W1, W2. The bottom surface 6 has an inner recess or round that extends along the central zone 9, substantially from the first intermediate zone 15 to the third intermediate zone 19. In the first embodiment, the round has a uniform geometry. The top surface 7 has two slight projections formed by a greater thickness in the retention zones 16, 18. Also, the board is slightly narrower between the edges 4, 5, in the area of the second intermediate zone 17.

The board, according to the invention, can comprise geometries that differ from that described above and shown in the drawings.

The height of the board 1 is shown in cross section in FIG. 2.

From the gliding surface 6 to the receiving surface 7, the board 1 includes a sole 21, a lower reinforcement 22, a core 23, an upper reinforcement 24 and a protective layer 25. The lower reinforcement 22, or load-carrying layer, is the closer of the two reinforcements to the ground when the board glides under normal operating conditions. By analogy, the upper reinforcement 24, or load-carrying layer, is the farther from the ground under the same conditions. Each reinforcement 22, 24, or reinforcement layer, includes, for example, synthetic fibers and/or natural fibers affixed together by a resin or any equivalent material(s).

Depending upon the type of board, the number of reinforcements can be modified and can include more than two such reinforcements.

Each reinforcement 22, 24, or reinforcement layer, extends parallel to the bottom surface 6 or to the top surface 7. It is possible for the board not to include any protective layer.

The sole 21 is made, for example, of a plastic material containing polyethylene. The protective layer 25 is made, for example, of a plastic material containing acetyl-butadiene-styrene.

The core 23 extends along a substantial surface of the board 1, i.e., almost from the first end 2 to the second end 3 lengthwise and from the first edge 4 to the second edge 5 widthwise. However, the core 23 could extend along a substantial surface while alternatively remaining setback relative to an end or an edge. In a non-limiting construction, the core 23 here includes two distinct portions, namely a first lateral portion 26, located on the side of the first lateral edge 4, and a second lateral portion 27, located on the side of the second lateral edge 5. This arrangement will be described in detail hereinafter.

The reinforcements 22, 24 and the core 23 form a sandwich panel or construction which extends along at least 50% of the surface of the board and, in a particular embodiment, substantially along the entire surface.

The board 1 further includes a first lateral beam 31 located in the area of the first lateral edge 4, and a second lateral beam 32 located in the area of the second lateral edge 5. This provides the board with a box-type structure. Each beam 31, 32, in an exemplary embodiment, includes a synthetic material, such as acetyl-butadiene-styrene, for example.

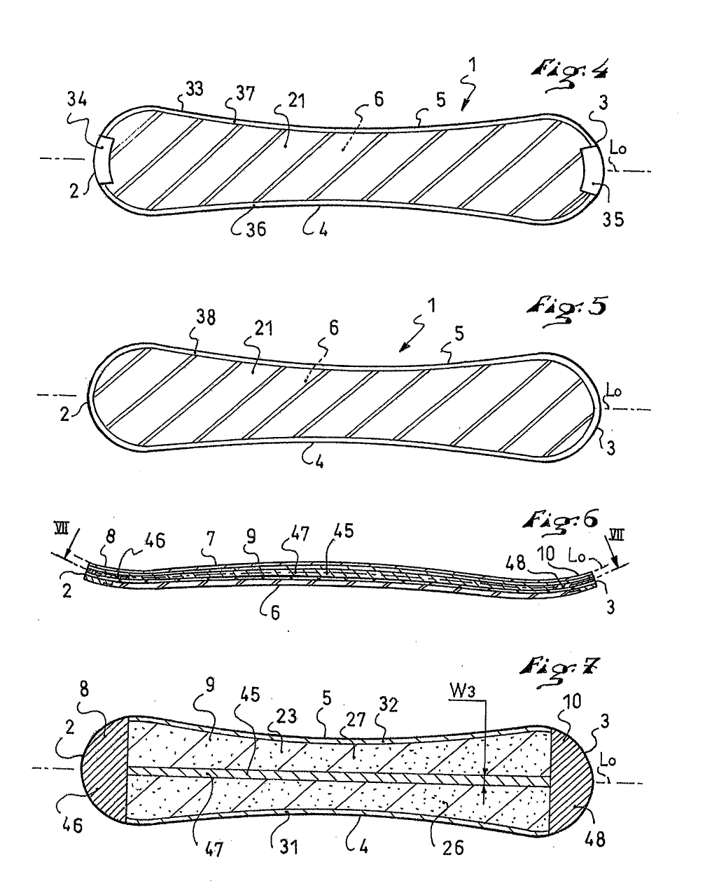

As can be understood from FIG. 2 and FIG. 4, also provided is a peripheral running edge 33 that extends along the sole 21. In the illustrated embodiment, the running edge 33 is sectioned and includes, for example, a first end subdivision 34 opposite a second end subdivision 35, as well as a first lateral subdivision 36 opposite a second lateral subdivision 37. The four subdivisions extend one another at the periphery of the board 1. The end subdivisions 34, 35 can be provided to be made of metal, such as aluminum alloy, and the lateral subdivisions 36, 37 can be provided to be also made of metal, such as steel or any equivalent.

Alternatively, as shown in FIG. 5, a running edge structure can be provided which is part of the first embodiment of the invention. According to this alternative, the board 1 includes a continuous peripheral running edge 38. The running edge 38 is made of metal, metal alloy, or the like.

According to the invention, as can be understood from FIGS. 2, 6, and 7, the board 1 includes a median longitudinal spacer 45, the spacer being arranged between the lower reinforcement 22 and the upper reinforcement 24. By its arrangement, the spacer 45 is transversely midway between the first lateral edge 4 and the second lateral edge 5. Therefore, the spacer 45 is cut in half lengthwise when the board 1 itself is sectioned longitudinally in the middle. Consequently, each half-board obtained includes a portion of the spacer 45. This portion maintains or contributes to maintaining the upper and lower reinforcements with respect to one another, along all or part of the cut. Therefore, the mechanical strength of each half-board is greater than it would have been if the original board were devoid of a spacer. As will be seen better hereinafter, each spacer portion can be structured and arranged to improve the physical strength of the board, especially with respect to water.

According to the first embodiment, the spacer 45 connects the lower reinforcement 22 directly to the upper reinforcement 24. The spacer 45 is affixed to each of the reinforcements 22, 24 with any of a number of means, mechanisms, or materials, such as glue, for example. Thusly, the reinforcements 22, 24 are held relative to one another, by preventing them from relatively moving away from or closer to one another. In other words, the improvement to the mechanical strength is optimized by means of this direct connection. It will be better understood hereinafter that this characteristic reinforces an edge of each narrow board obtained by cutting the original board 1.

Still in order to optimize the mechanical strength, the spacer 45 extends from the first end 2 to the second end 3 of the board 1. In other words, the spacer 45 extends along the entire board 1, in the middle thereof. This characteristic has the additional advantage of sealing the central longitudinal section of the board 1. Thus, after the longitudinal cut, as will be seen hereinafter, the cut edge of each half-board is impervious. The imperviousness prevents the penetration of foreign bodies, debris or material, such as water. Advantageously, the result is a longer life for the board.

As shown in FIG. 7, the spacer 45 is comprised of sections 46, 47, 48 of various widths. It is to be understood that the widths of the sections are measured in the transverse direction Wo. More precisely, the spacer 45 includes, from the first end 2 to the second end 3, a first end section 46, a central section 47, and a second end section 48. The first section 46 extends along the first end 2, and from the first lateral edge 4 to the second lateral edge 5. By analogy, the second section 48 extends along the second end 3, and from the first lateral edge 4 to the second lateral edge 5. These end sections 46; 48 occupy the width of the board 1, or at least substantially the width of the board, and have a reduced thickness. For example, the thickness is between 0.5 and 5 millimeters (mm). In particular embodiments, thicknesses of 1 to 3 mm yield good results. It is to be understood that the thickness is measured heightwise of the board 1. The advantage of having a substantial width for the spacer 45, in the area of the ends 2, 3, and therefore in the area of the first end zone 8 and the second end zone 10, is to facilitate the manufacture of the board. Indeed, the thickness of the board is reduced towards the ends 2, 3. By contrast, the central section 47 is narrow between the first end section 46 and the second end section 48. The central section 47 extends in the central zone 9, and has a width W3 ranging between 5 and 80 mm. In particular embodiments, widths of between 10 and 40 mm yield satisfactory results. It is to be understood that the first lateral portion 26 and the second lateral portion 27 of the core 23 are arranged on both sides, respectively, of the central section 47 of the spacer 45, in the central zone 9 of the board 1. This preserves the benefits bestowed by the spacer 45, while making the board lighter. Indeed, the core 23 is comprised of a lightweight, low density material, such as plastic foam, wood, or any equivalent. The density of the core 23, and therefore the density of each portion 26, 27, ranges between 0.15 and 0.8, for example, knowing that with values of 0.2 to 0.5, the board 1 has good inertia properties.

In addition, the three sections 46, 47, 48 are separate but butt-joined elements. As a result, the spacer 45 is continuous, from the first end 2 to the second end 3. Alternatively, these three sections can be provided to form a single piece. In any case, the imperviousness mentioned previously is preserved; and it is all the more preserved as the upper reinforcement 24 extends continuously opposite the spacer 45 and the lower reinforcement 22 also extends continuously opposite the spacer 45.

To simplify the manufacture of the board 1, as shown in FIG. 2, the cross section of the central section 47 of the spacer 45 can be parallelepipedic. For example, the section 47 has a square or rectangular transverse cross section.

The spacer 45 is made, for example, of a plastic or synthetic material, such as acetyl-butadiene-styrene, polyamide, polyurethane, or any equivalent. These materials are impervious and easy to implement. It follows naturally that the sections 46, 47, 48 can be made of, these materials. However, each of the sections can be provided to be made of the same material, or for different sections to be made of different materials.

The board 1, with its structural features mentioned hereinabove, can be cut as can be understood from FIGS. 10 and 11. The cut is made along the longitudinal median line, designated by the reference Lo. For example, the cut is made with a jigsaw or a band saw.

As shown in FIG. 10, the only cut of the board 1 provides two half-boards 51, 52. The first half-board 51 extends lengthwise from the first end 2 to the second end 3, and widthwise between the first lateral edge 4 and a cut edge 53. Similarly, the second half-board 52 extends lengthwise from the first end 2 to the second end 3, and widthwise between the second lateral edge 5 and a cut up edge 54. Each of the cut edges 53, 54 is demarcated by a subdivision of the spacer 45, which has been cut.

The half-boards 51, 52 can be used separately, like skis, or conversely can be affixed to each other to form an apparatus that resembles the original board 1. In other words, in the context of the invention, the narrow boards can be used as skis, with each foot/boot of the skier, or rider, affixed to a respective narrow board, or the narrow boards can be affixed to each other to form a wide board.

As shown in FIG. 11, the ends 2, 3 of the half-boards 51, 52 can be provided to be rounded, such by means of cutting, sawing, and/or sanding, or other machining or manual shaping, which makes them easier to use as skis. In addition, rounded ends reduce the risks of injuries resulting, for example, from unskillful handling.

The second embodiment of the invention is now illustrated using FIGS. 1, 3 to 5, and 8 to 11. For reasons of convenience, elements common with the first embodiment are designated by the same reference numerals.

As can be understood from FIGS. 1 and 3 to 5, the second embodiment includes a board 1, having the ends 2, 3, the lateral edges 4, 5, the sole 21, the lower reinforcement 22, the core 23, the upper reinforcement 24 and the protective layer 25. The embodiment also offers a choice between a sectioned running edge 33 and a continuous running edge 38.

A particular characteristic of the board 1, shown in FIG. 3, is in the area of its lateral edges 4, 5. Indeed, the lower reinforcement 22 and the upper reinforcement 24 here connect directly to one another in the area of the lateral edges 4, 5. This provides the board 1 with a cap or shell-type construction, which avoids the use of beams 31, 32 as seen previously. The board according to the second embodiment is therefore an alternative construction, which makes the board 1 highly resistant to twisting along a longitudinal axis.

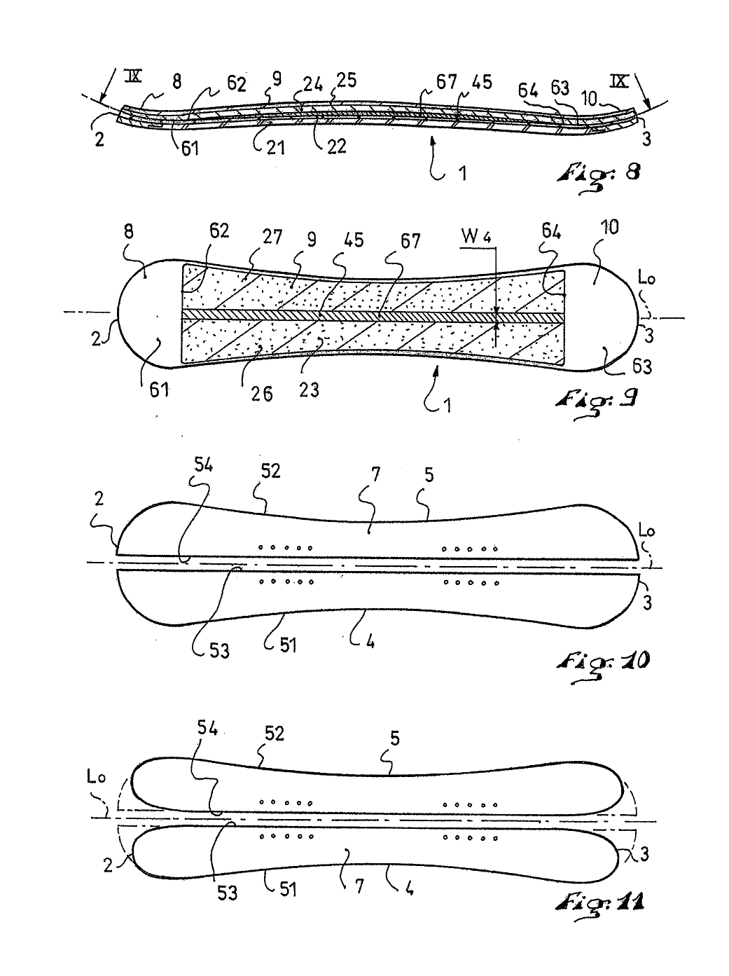

As can be seen in FIGS. 8 and 9, the lower 22 and upper 24 reinforcements connect directly to one another in the first end zone 8 and in the second end zone 10 of the board 1. More precisely, and in a non-limiting fashion, a first zone 61 for attaching the reinforcements 22, 24 to one another extends from the first end 2 toward the central zone 9, up to a first boundary or junction 62. The junction 62 separates the first attachment zone 61 from the core 23. The junction 62 is located, for example, in the area of the boundary between the first end zone 8 and the central zone 9; but this is not mandatory. Similarly, a second zone 63 for attaching the reinforcements 22, 24 to one another extends from the second end 3 towards the central zone 9, up to a second boundary or junction 64. The junction 64 separates the second attachment zone 63 from the core 23. The junction 64 is located, for example, in area of the boundary between the second end zone and the central zone 9. Also, the zones 61, 63, like end sections 46, 48 of the first embodiment, occupy the width of the board 1, or substantially the width of the board.

Each junction 62, 64 is rectilinear and oriented in the transverse direction Wo of the board 1. As a result, the board is symmetrical along the median longitudinal axis Lo.

According to the invention, the spacer 45 extends from the first junction 62 to the second junction 64. In this case, the spacer 45 includes a single section 67, which is similar to the central section 47 of the first embodiment. In the context of the invention, the section 67 is arranged along the median longitudinal direction Lo of the board 1. The section 67 of the second embodiment has the same technical characteristics as those of the section 47 of the first embodiment. In particular, the section 67 or, in this case, the spacer 45, has a width W4 that is constant from the first junction 62 to the second junction 64, which facilitates manufacture. However, the width of the section 67 can be constructed to vary.

Also, the structure of the spacer is continuous and solid, for better sealing after the cut.

Further, the core 23 includes a first lateral portion 26 and a second lateral portion 27.

Ultimately, the board 1 according to the second embodiment can be cut into two half-boards 51, 52, as described above with regard to the first embodiment, with reference to FIGS. 10 and 11. In this regard, as mentioned above in connection with the first embodiment, and as shown in FIG. 11, e.g., the ends 2, 3 of the half-boards 51, 52 can be provided to be rounded, such by means of cutting, sawing, and/or sanding, or other machining or manual shaping, which makes them easier to use as skis. According to a particular feature of embodiments of the invention, for facilitating such shaping, such shaping can be done completely within the respective peripheries of the first and second end sections 46, 48 of the spacer of the first embodiment, or completely within the respective peripheries of the first and second zones 61, 63 for attaching the upper and lower reinforcements to one another of the second embodiment.

In general, the invention is made from materials and using techniques of implementation known to one of ordinary skill in the art.

The invention is not limited to the embodiment described hereinabove, and includes all technical equivalents that fall within the scope of the claims that follow.

In particular, a number of structures or various materials can be provided for manufacturing the spacer 45.

The board 1 may be devoid of a core, completely or partially. In such a case, the board 1 has two cavities, one between a lateral edge 4 and the spacer 45, and the other between the other lateral edge 5 and the spacer 45.

The invention illustratively disclosed herein suitably may be practiced in the absence of any element which is not specifically disclosed herein.

1. A gliding board comprising:
a length measured along a longitudinal direction between a first end and a second end;
a width measured along a transverse direction between a first edge and a second edge;
a height measured between a bottom surface and a top surface;
a lower reinforcement;
an upper reinforcement,
a median longitudinal spacer, the spacer being arranged between the lower reinforcement and the upper reinforcement.

2. A gliding board according to claim 1, wherein:
the spacer directly, connects the lower reinforcement to the upper reinforcement.

3. A gliding board according to claim 1, wherein:
the spacer extends from the first end to the second end of the board.

4. A gliding board according to claim 3, wherein:
the spacer comprises sections of various widths.

5. A gliding board according to claim 4, wherein:
the spacer includes, from the first end until the second end, a first end section, a central section, and a second end second;
between the first and second end sections, the central section is narrow.

6. A gliding board according to claim 1, wherein:
a first zone for connecting the upper and lower reinforcements extends from the first end to a junction;
a second connection zone for connecting the upper and lower reinforcements extends from the second end to a junction; and
the spacer extends from the first junction to the second junction.

7. A gliding board according to claim 6, wherein:
the spacer has a width constant from the first junction to second.

8. A gliding board according to claim 1, wherein:
a longitudinally central section of the spacer is parallelepipedic.

9. A gliding board according to claim 1, wherein:
the spacer is made with a plastic or synthetic material.

10. A gliding board according to claim 1, wherein:
the structure of the spacer is continuous.

11. A gliding board according to claim 1, wherein:
the gliding board includes a first end zone having a length extending from a first transverse contact line to a first end of the gliding board, and a second end zone having a length extending from a second transverse contact line to a second end of the gliding board;
a first zone for attaching the upper and lower reinforcements to one another occupy at least substantially the width of the gliding board in the first end zone and substantially the length of the first end zone;
a second zone for attaching the upper and lower reinforcements to one another occupy at least substantially the width of the gliding board in the second end zone and substantially the length of the second end zone.

12. A gliding board according to claim 11, wherein:
the board has a cap construction.

13. A gliding board according to claim 11, wherein:
the board has a sandwich construction.

14. A gliding board according to claim 13, wherein:
the first and second zones for attaching the upper and lower reinforcements to one another are first and second end sections of the spacer;
a longitudinally central section of the spacer extends from the first end section to the second end section of the spacer.

15. A gliding board according to claim 14, wherein:
the central section of the spacer has a width between 10 and 80 mm.

16. A gliding board according to claim 12, wherein:
the spacer extends longitudinally from the first zone for attaching the upper and lower reinforcements to one another to the second zone for attaching the upper and lower reinforcements to one another.

17. A gliding board according to claim 16, wherein:
the central section of the spacer has a width between 10 and 80 mm.
